(19) United States
(12) Patent Application Publication
(10) Pub. No.: US 2007/0281602 A1
(43) Pub. Date: Dec. 6, 2007

(54) Suit coat ventilation mechanism

(76) Inventor: Morris Lucian Barwick, Greenville, TX (US)

Correspondence Address: MORRIS L. BARWICK, 5113 F M 2101, GREENVILLE, TX, 75402, US

(21) Appl. No.: 11/805,895

(22) Filed: May 25, 2007

Related U.S. Application Data
(60) Provisional application No. 60/809,243, filed on May 30, 2006.

(51) Int. Cl. B08B 15/00; A41F 9/00

(52) U.S. Cl. 454/370; 2/1

(57) ABSTRACT

A ventilation mechanism for air exhaust from beneath an article of clothing or apparatus such as a Suit Coat, Bullet Proof vest, Flak Jacket or task protective covering, to prevent heat discomfort of the wearer. The inventive device includes a small air moving assembly powered by batteries, worn beneath an outer covering, which exhausts the warmer and high humidity air from beneath the covering causing fresh external air to infiltrate the exhausted volume.

### CROSS-REFERENCE TO RELATED APPLICATIONS

This application claims the benefit of Provisional Patent Application, Docket No. MLB200, Application No. 60/809,243 filed May 30, 2006, which includes the design concepts and features cited herein.

### STATEMENT REGARDING FEDERALLY SPONSORED RESEARCH AND DEVELOPMENT

Not Applicable.

### BACKGROUND OF THE INVENTION

1. Field of the Invention

The present invention relates generally to a coat ventilator and more specifically it relates to a portable suit coat ventilation mechanism for air exchange within a piece of clothing to prevent heat discomfort of a person wearing a suit coat or other piece of clothing. It is also proposed for ventilation beneath uniforms, working garments and personal protection garments and devices.

2. Description of the Prior Art

It can be appreciated that personal cooling fans have been in use for years. Typically, they are comprised of hand held or neck strap supported, axial flow propeller fans being battery operated personal cooling fans. A garment is commercially offered containing built in cooling fans to be donned specifically for the cooling feature.

The main problem with conventional personal cooling fans is they are intended to cause airflow to impinge on the user which requires directional guidance. They are hard to hold by hand for extended periods of time or to direct the airflow efficiently. Another problem with conventional personal cooling fans is that they do not efficiently remove the layer of high humidity air surrounding the body beneath outer coverings. This high humidity air is the result of the body perspiring in an effort to effect cooling. Another problem with prior art is that they do not lend themselves to concealment and low noise generation. Another problem with prior art personal cooling fans is that they do not have battery life extending capabilities. Another problem with prior art is they are not supportive of other personal garments or devices.

While these devices may be suitable for the particular purpose to which they address, they are not as suitable for air exchange within a piece of clothing or personally worn apparatus to prevent the heat discomfort of a person wearing said items.

In these respects, the suit coat ventilation mechanism according to the present invention substantially departs from the conventional concepts and designs of the prior art, and in so doing provides an apparatus primarily developed for the purpose of air exchange within an interchangeably selectable garment to prevent the heat discomfort of a person wearing said garment.

### BRIEF SUMMARY OF THE INVENTION

In view of the foregoing disadvantages inherent in the known types of personal portable cooling devices now present in the prior art, the present invention provides a new suit coat ventilation mechanism construction wherein the same can be utilized for air exchange beneath a piece of clothing to prevent heat discomfort of a person wearing a suit coat or other.

The general purpose of the present invention, which will be described subsequently in greater detail, is to provide a new suit coat ventilation mechanism that has many of the advantages of the personal cooling fans mentioned heretofore and many novel features that result in a new suit coat ventilation mechanism which is not anticipated, rendered obvious, suggested, or even implied by any of the prior art personal cooling fans, either alone or in any combination thereof. My inventive device also can offer battery life extending features.

### BRIEF DESCRIPTION OF THE SEVERAL VIEWS OF THE DRAWING

FIG. 1. A general construction and assembly of a right-handed COAT VENTILATOR.

FIG. 2. The same assembly as in FIG. 1, but exploded to show significant portions.

FIG. 3. A view looking down from above of the COAT VENTILATOR being worn in a suit coat.

FIG. 4. Shows one of the several batteries in the normal mode supplying power. Beneath the graphic is the schematic of that mode.

FIG. 5. Shows a single battery physically moved away from its positive contact, initiating a by-passing current path and dropping battery array voltage by the voltage of that single battery. Beneath the graphic is the schematic of that alternate mode.

FIG. 6. Shows push rods to disconnect individual batteries.

FIG. 7 is schematically a chain of four batteries in high speed mode.

FIG. 8 has two of the four batteries disabled by the push rod for much lower speed and noise with the associated increase in battery life of the active batteries.

### DETAILED DESCRIPTION OF THE INVENTION

The present invention is generally comprised of a small air moving device such as, but not limited to, a radial blower or propeller type fan equipped with an inlet duct and a discharge duct, a method of securing in desired position, an array of batteries and an on/off switch. A speed control switch or other speed by voltage selection is presented. An axial fan is acceptable although it increases thickness of the assembly by ducting complexity. An air-gathering device surrounds the blower inlet, which precludes air from being returned from the discharge and provides reduction of radiated blower noise. The discharge duct directs air from the blower discharge port to a remote location out of the coat or controlled space. A flat planer member is attached to the air moving assembly which when placed into an inner coat pocket, or holder, will maintain position of said assembly. The assembly is constructed of molded plastic, probably of ABS plastic with a SUNON 40 mm×40 mm×9 mm, 5 Volt DC radial blower.

In use, the ventilating assembly is turned on using the on/off switch, if present, and a less than maximum speed may selected by either the speed selection switch or by disengaging a selected number of batteries supplying power. The action of disengaging a single battery is done by pressing the link that displaces the battery away from its battery box contact. This, in turn, allows that positive contact to spring outward and completes the circuit bypassing that battery position.

My experimental results have shown that a 5 VDC blower can be run on 6 VDC, 4.5 VDC and 3 VDC. When using only 2 batteries at 3 VDC, each battery is supplying about ½ the electrical current as when all 4 batteries are employed. Life of the two used batteries is considerably more than twice the life of full service life. By individually selecting batteries being used it is conceivable to extend the useful life of the 4 batteries much more than twice each, or 4 times for all.

Battery life extending comes from: Assuming a purely resistive load of 20 ohms, operating at 6 volts, each of 4 batteries must supply 300 milliamps of current. If the application allows useful results at 4.5 volts with 3 batteries, each battery must supply only 225 milliamps, a 13.3%, or more, increase in life. Even some applications can be useful or desirable at 3 volts. At 150 milliamps per battery, life of the two remaining batteries would be doubled, or more, or 4 times the life from interchanging the 4 batteries.

In an industrial or military application, more batteries may be employed to enable a higher voltage and capacity blower or fan.

There has thus been outlined, rather broadly, the more important features of my inventive SUIT COAT VENTILATION DEVICE, in order that the present contribution to the art may be better appreciated. There are additional features of the invention that will be described hereinafter.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of the description and should not be regarded as limiting.

A primary object of the present invention is to provide a suit coat ventilation mechanism that will overcome the shortcomings of the prior art personal cooling devices.

An object of the present invention is to provide a ventilation mechanism for air exchange within a piece of clothing or apparatus to prevent the heat discomfort of a person wearing same.

Another object is to provide a suit coat ventilation mechanism that transfers a high amount of high humidity air from beneath clothing, especially a coat, and exhausts it to the outside ambient, thereby causing fresh and lower humidity replenishment air to be drawn in from the ambient.

Another object is to provide a suit coat ventilation mechanism that will allow the wearing of a suit coat in warmer temperatures without excessive perspiring or discomfort of the wearer.

Another object is to provide a suit coat ventilation mechanism that will allow the cooling action of an integral tangential blower to operate for an extended period of time on battery power alone.

Another object is to provide a suit coat ventilation mechanism that will allow the cooling action of an integral tangential blower to operate for an extended period of time without excessive noise or without detection by others.

Another object is to provide a suit coat ventilation mechanism that will allow the speed of the integral blower to be varied as desired in order to increase/decrease cooling while increasing/decreasing noise. This can be accomplished by the incorporation of a more complex battery selection switch, or other battery selection means.

Other objects and advantages of the present invention will become obvious to the reader and it is intended that these objects and advantages are within the scope of the present invention.

To the accomplishment of the above and related objects, this invention may be embodied in the form illustrated in the accompanying drawings, attention being called to the fact, however, that the drawings are illustrative only, and that changes may be made in the specific construction illustrated.

Various other objects, features and attendant advantages of the present invention will become fully appreciated as the same becomes better understood when considered in conjunction with the accompanying drawings, in which like reference characters designate the same or similar parts throughout the several views, and wherein:

### DESCRIPTION OF THE PREFERRED EMBODIMENT

Turning now descriptively to the drawings, in which similar reference characters denote similar elements throughout the several views, the attached figures illustrate a suit coat ventilation mechanism.

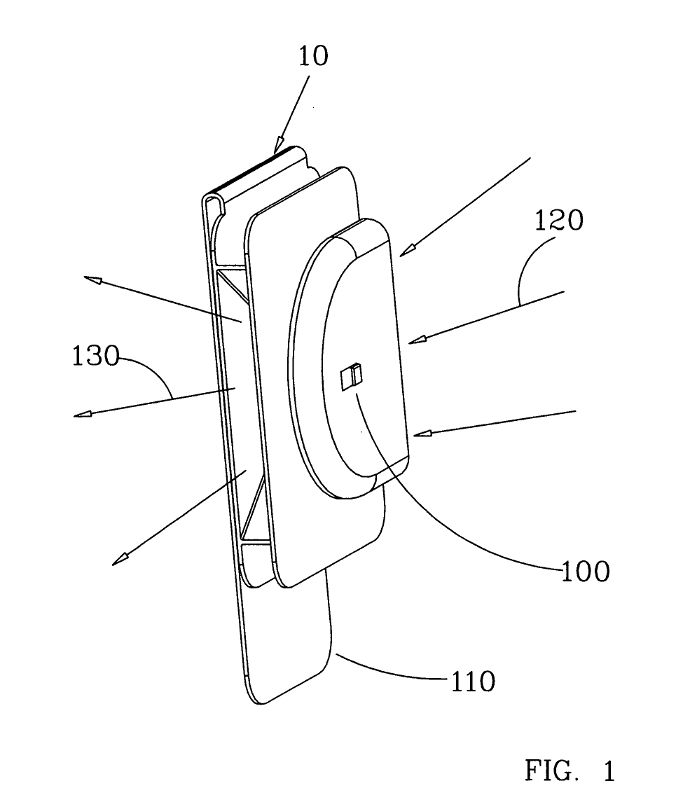

FIG. 1 shows the assembly 10 with inlet air flow 120 from the general armpit vicinity and being discharged 130 toward the necktie region. The on/off switch 100 and the pocket mount 110 is shown.

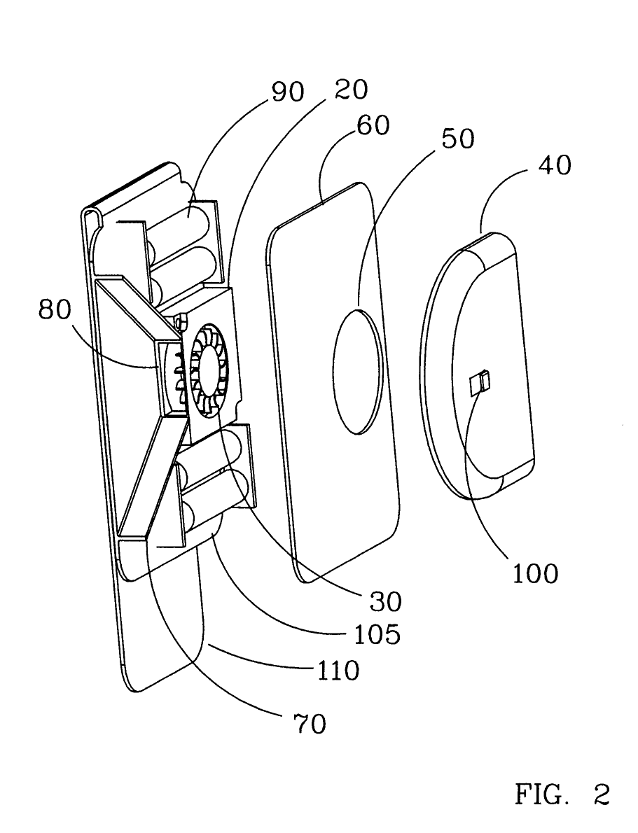

FIG. 2 is an exploded view of the assembly and shows the blower 20, the blower air inlet 30, the inlet duct 40, which is an air-gathering device at the blower inlet 30, which precludes air from being returned from the discharge port 80, and provides reduction of blower noise, the top plate 60 with the inlet hole 50. Also shown is the discharge chute 70. The batteries 90 are removable as required by removal of 60. It is proposed that the bottom plate 105 is integral with the pocket mount 110, but removable to change right hand to left hand assembly. The pocket mount is a flat planer member 110, which when placed into an inner coat pocket, will maintain position. By changing ends of fixity of the ventilating assembly to the pocket mount, it can be changed to a left hand assembly, directing air from the left hand shirt pocket vicinity toward the necktie vicinity. A person could wear a ventilating assembly on both sides simultaneously if desired.

The discharge chute directs air from the blower discharge port 80 out of the coat or controlled space. The discharge duct directs all air being discharged by the blower to uncontrolled areas, usually from out behind the coat lapel. The discharge duct could connect to a flexible tubing and direct air to a remote location out of any place where the ventilator assembly is located.

The pocket holder 110, is a thin plate of such dimensions in length as to rest on the bottom of a suit coat pocket while protruding a small amount above edge of said pocket and wide enough to be stable. The plate inside the coat pocket could contain the battery pack but would add thickness to the assembly.

The batteries used in my design of the “AAA” size. Larger batteries are optional as desired for longer duration. It is noted that the envelope dimensions of my present design are less than 3 inches wide by 4 inches long by 1¼ in thick. Larger batteries would have an immediate impact on mostly the thickness and the weight. A simple switch 100 is employed to cease or initiate operation of the blower. The switch is a SPST slide switch. A push button, or other, switch could be used if protected from accidental activation. Speed control can be effected by the engagement or disengagement of individual batteries powering the air mover. A single pole multiple throw switch could select less than all batteries. This would not be required if employing my inventive battery selection.

The blower is sandwiched between two planar surfaces or plates 110, or 105 and 60. Plate 105 might be a separate plate the size of 60. The plate at the blower inlet face has a hole for air passage into the blower and has the inlet collection duct 40 mounted to it on the far side from the blower. This duct directs air from deeper inside the coat and into the inlet of the blower. The discharge duct is sandwiched between these two plates and adjacent to the discharge of the blower 80. It directs air from the blower away from the area where said blower is located. The pocket mount 110 can attach to the blower assembly at the top edge of the pocket in a temporarily fixed manner. A right hand cooling assembly directs air from the right hand shirt pocket vicinity toward the necktie vicinity

Usage involves the ventilating assembly is turned on using the integral on/off switch and a speed is selected. The pocket mount is placed into the coat pocket with the ventilating assembly being outside the pocket and blower inlet toward the wearer, thereby receiving its air from the general armpit vicinity. Battery endurance has been demonstrated to be in excess of 20 hours using “AAA” batteries and noise significantly less than 30 db.

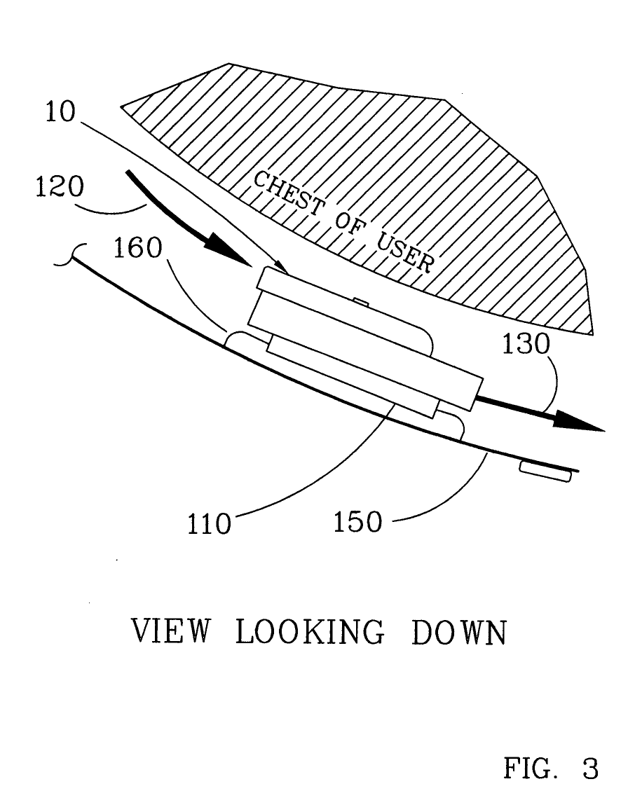

FIG. 3 depicts a view from above showing my ventilator assembly 10 inserted into the inner right hand suit coat 150 pocket 160.

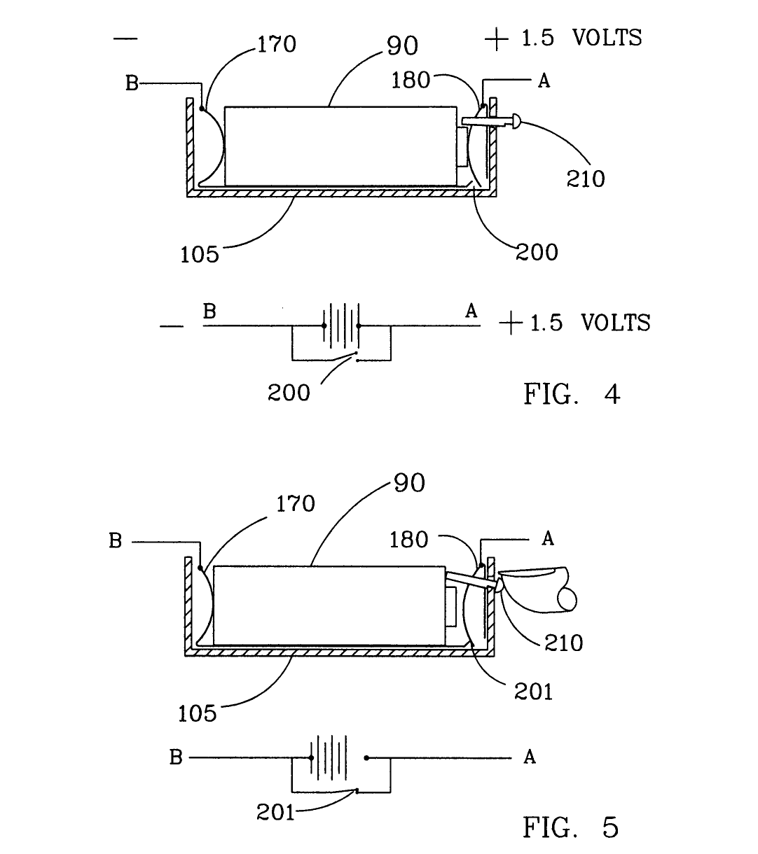

In addition to a standard battery box and depending on switches for on-off and quantity of batteries for voltage supply, it is proposed to alternately supply battery power using my referenced Patent Pending “BATTERY BYPASSING CONTACT” as described in FIG. 4 and FIG. 5.

In FIG. 4, battery 90, is making positive contact with the positive spring clip 180, and with the negative spring contact 179. Beneath each view is the schematic of the respective arrangement. The battery has deflected clip 180, causing the “Normally Closed Contacts” 200, to open. Clip 180 is not electrically connected to clip 170 and electrical current from A to B passes through the battery with the voltage increase of said battery. Item 210, is a push rod to translate the battery for disconnect.

In FIG. 5, a finger has pressed 210 against the battery, causing axial translation and disconnect of the battery and compressing the negative clip 170. Push rod 210, locks in this position preventing the return of the battery and eliminating compression of, or contact with 180.

With the battery moved away from 180, then 180 is now free to spring outward thereby closing the gap 200 to a conducting state 201. As noted in the associated schematic the new current path bypasses the battery with no increase in voltage.

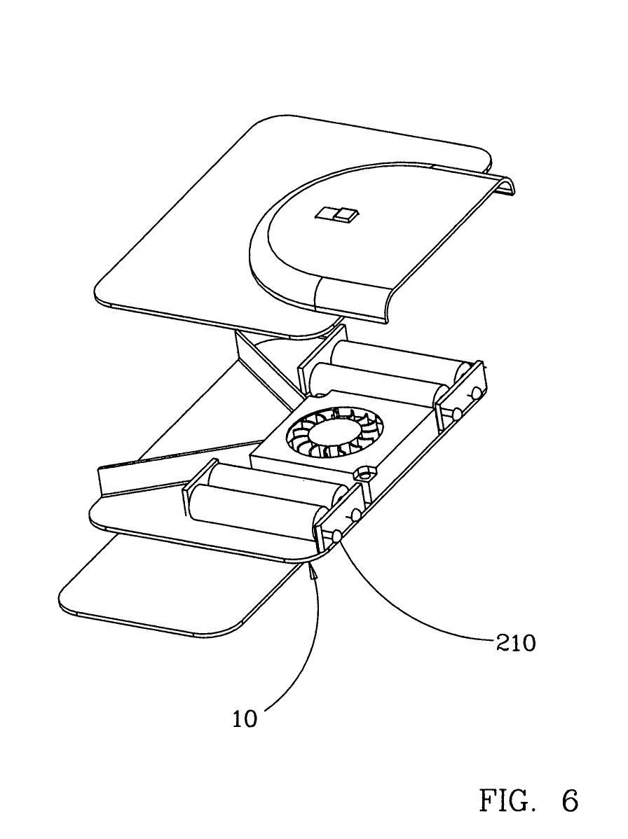

FIG. 6 shows the push rods 210, that each, when pushed, translate the battery away from the positive contact and removes that battery from service.

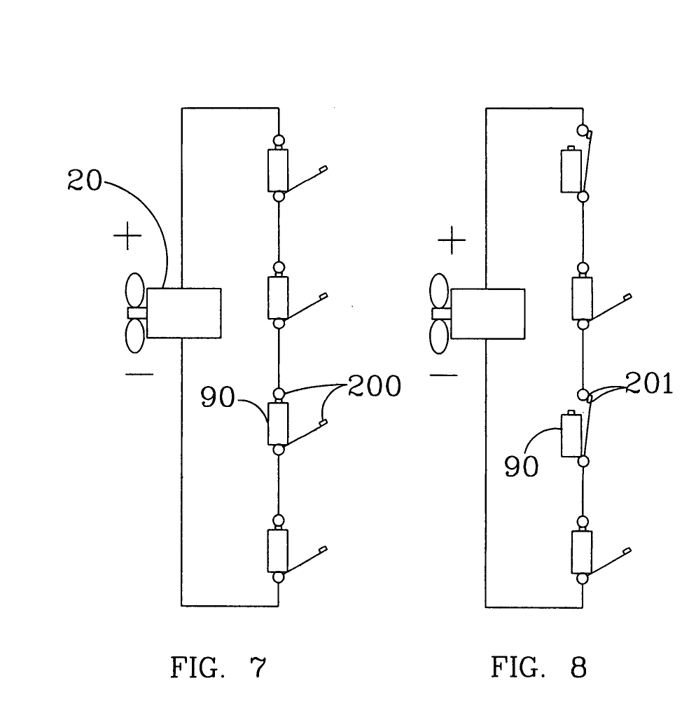

FIG. 7 shows the battery schematic at high speed with all batteries contributing power.

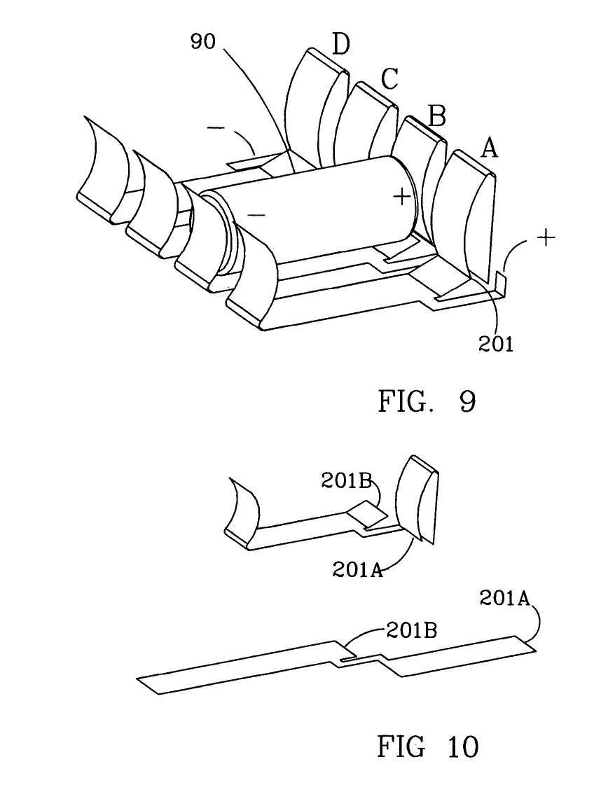

FIG. 8 schematically shows two batteries physically moved away from their contacts with their position being bypassed by carrying current past the empty position.

FIG. 9 is a four battery array using my special singularly selectable contacts.

FIG. 10 is a view of the flat pattern of spring temper metal used to make each battery position and the formed contact as used. Notice all interbattery connections are provided by the contacts with no assembly wiring required. 201A will form bypassing circuit 201 when installed.

As to a further discussion of the manner of usage and operation of the present invention, the same should be apparent from the above description. Accordingly, no further discussion relating to the manner of usage and operation will be provided.

With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

I claim to have invented:

1. A battery powered personal air exhaust system to be placed beneath and independent of an outer garment or device or apparatus for the purpose of reducing heat discomfort of the wearer by expelling the warm and moist air from beneath said garment and thereby causing replacement of said air with ambient potentially dryer and cooler air.
a) The device of claim 1 being speed and/or operationally controlled by a selection switch of one or more powering batteries.
b) The device of claim 1 being speed and/or operationally controlled by selection of one or more powering batteries by physically repositioning or removal of individual powering batteries.
c) The device of claim 1 being incorporated into a garment or device or apparatus dedicated to the performance of a unique task or activity.
